(19) United States
(12) Patent Application Publication
(10) Pub. No.: US 2025/0287093 A1
(43) Pub. Date: Sep. 11, 2025

(54) ELECTRONIC DEVICE PROVIDING FILTER FUNCTION AND OPERATION METHOD THEREOF

(71) Applicant: Samsung Electronics Co., Ltd., Suwon-si (KR)

(72) Inventor: Sihyoung LEE, Suwon-si (KR)

(21) Appl. No.: 19/220,533

(22) Filed: May 28, 2025

Related U.S. Application Data
(63) Continuation of application No. PCT/KR2023/017712, filed on Nov. 7, 2023.

(30) Foreign Application Priority Data
Nov. 28, 2022 (KR) 10-2022-0161639
Jan. 4, 2023 (KR) 10-2023-0001239

(51) Int. Cl. H04N 23/63; H04N 23/71

(52) U.S. Cl. CPC H04N 23/632; H04N 23/633; H04N 23/71

(57) ABSTRACT

An electronic device is provided. The electronic device includes a display which provides a preview, a camera including an image sensor, a memory which stores instructions, and at least one processor communicatively coupled to the display, the camera, and the memory. The instructions, when executed by the at least one processor individually or collectively, cause the electronic device to display a shooting setting including at least one first set value and a second set value through the display, change the at least one first set value which determines a shutter speed when the second set value which determines strength of a neural density (ND) filter is changed by a user input, and display the changed shooting setting through the display along with the preview.

### CROSS-REFERENCE TO RELATED APPLICATION(S)

This application is a continuation application, claiming priority under 35 U.S.C. § 365 (c), of an International application No. PCT/KR2023/017712, filed on Nov. 7, 2023, which is based on and claims the benefit of a Korean patent application number 10-2022-0161639, filed on Nov. 28, 2022, in the Korean Intellectual Property Office, and of a Korean patent application number 10-2023-0001239, filed on Jan. 4, 2023, in the Korean Intellectual Property Office, the disclosure of each of which is incorporated by reference herein in its entirety.

### BACKGROUND

### 1. Field

The disclosure relates to an electronic device providing a filter function, and an operation method thereof.

### 2. Description of Related Art

Long exposure photos not only capture a moment but also represent a time flow. A camera may provide the long exposure photo by slowing down a shutter speed to capture a flow of light in the photo. In order to obtain the long exposure photo, a time for light to enter an image sensor shall be increased by setting the shutter speed to be slow.

When the image sensor is overexposed with the increase in the time for the light to enter the image sensor due to the slowed-down shutter speed, it is difficult to accurately capture motions in the photo. To solve this problem, a neutral density (ND) filter may be attached to a camera lens to reduce an amount of light while maintaining the shutter speed, allowing the motion in the photo to be expressed with a proper exposure.

Meanwhile, the ND filter is usually implemented as hardware mountable on the camera lens, but may also be implemented as software. If the ND filter is implemented as software, a relationship between a shooting setting (e.g., sensitivity (ISO), shutter speed) in a camera and a set value of the ND filter shall be considered in order to achieve perfection of the long exposure photo.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a long exposure photo with high perfection without a hardware neutral density (ND) filter.

Another aspect of the disclosure is to provide software providing an ND filter function, and may provide a proper shooting setting based on set values of various ND filters.

Additional aspects will be set forth in part in the description which follows and, in part, will be apparent from the description, or may be learned by practice of the presented embodiments.

In accordance with an aspect of the disclosure, an electronic device is provided. The electronic device includes a display which provides a preview, a camera including an image sensor, a memory which stores instructions, and at least one processor communicatively coupled to the display, the camera, and the memory. The instructions, when executed by the at least one processor individually or collectively, may cause the electronic device to display a shooting setting including at least one first set value and a second set value through the display, change the at least one first set value which determines a shutter speed when the second set value which determines strength of a ND filter is changed by a user input, and display the changed shooting setting through the display along with the preview.

In accordance with another aspect of the disclosure, a method performed by an electronic device is provided. The method may include displaying a shooting setting including at least one first set value and a second set value through the display, changing the at least one first set value which determines a shutter speed when the second set value which determines strength of an ND filter is changed by a user input, and displaying the changed shooting setting through the display along with the preview.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations may include displaying a shooting setting including at least one first set value and a second set value through a display, changing the at least one first set value which determines a shutter speed when the second set value which determines strength of an ND filter is changed by a user input, and displaying the changed shooting setting through the display along with the preview.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram illustrating a camera module, according to an embodiment of the disclosure;

FIG. 3 is a block diagram of an electronic device according to an embodiment of the disclosure;

FIG. 4 illustrates a user interface displayed for an electronic device to provide a neutral density (ND) filter function according to an embodiment of the disclosure;

FIG. 5 is a drawing for explaining an operation of creating a long exposure image by using a short exposure image according to an embodiment of the disclosure;

FIG. 6 is a flowchart of an operation method in which an electronic device creates a long exposure photo according to an embodiment of the disclosure;

FIG. 7 is a flowchart of an operation method in which an electronic device changes a preview and a shooting setting according to an embodiment of the disclosure;

FIG. 8 is a drawing for explaining a change in brightness of the preview when strength of an ND filter is adjusted in an electronic device according to an embodiment of the disclosure;

FIG. 9 is a flowchart of an operation method in which a shooting setting and brightness of a preview change when a first set value is adjusted in an electronic device according to an embodiment of the disclosure;

FIG. 10 is a drawing to be referred to in the operation method according to FIG. 9 according to an embodiment of the disclosure;

FIG. 11 is a flowchart of an operation method in which a set value of an ND filter changes when a first set value is adjusted in an electronic device according to an embodiment of the disclosure;

FIG. 12 is a drawing to be referred to in the operation method according to FIG. 11 according to an embodiment of the disclosure;

FIG. 13 is a flowchart of an operation method in which a first set value changes when a set value of an ND filter is adjusted in an electronic device according to an embodiment of the disclosure;

FIG. 14 is a drawing to be referred to in the operation method according to FIG. 13 according to an embodiment of the disclosure;

FIG. 15 illustrates examples of a shooting setting based on whether an ND filter function is present or absent according to an embodiment of the disclosure;

FIG. 16 is a flowchart of an operation method in which a setting range of a first set value changes when a set value of an ND filter is adjusted in an electronic device according to an embodiment of the disclosure;

FIG. 17 is a drawing to be referred to in the operation method according to FIG. 16 according to an embodiment of the disclosure; and

FIG. 18 illustrates examples in which a shutter speed is restricted based on a set value of an ND filter according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

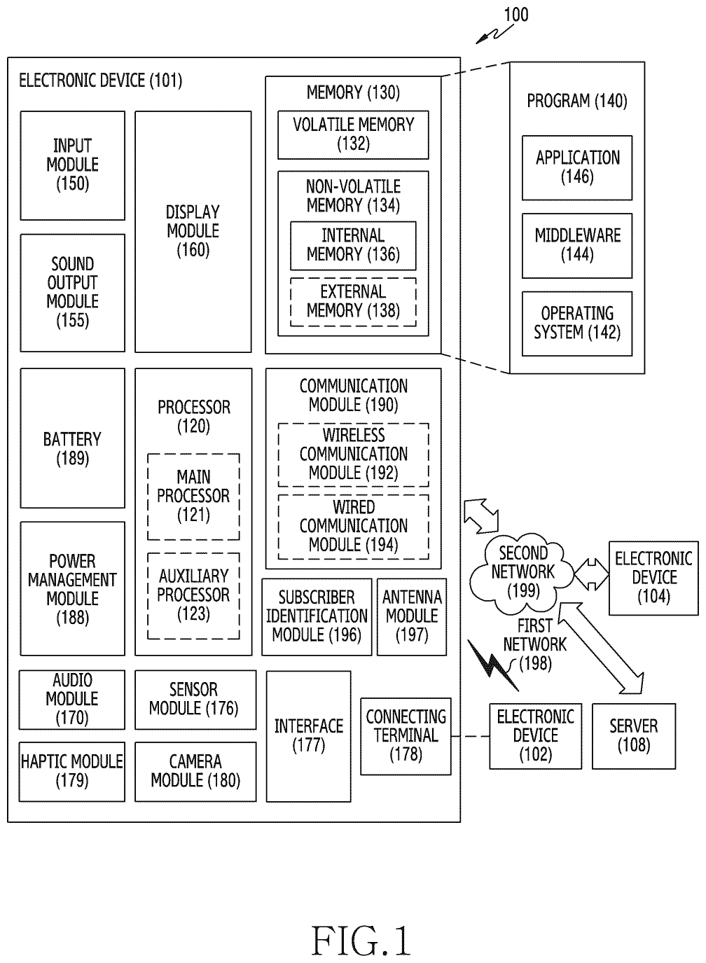

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

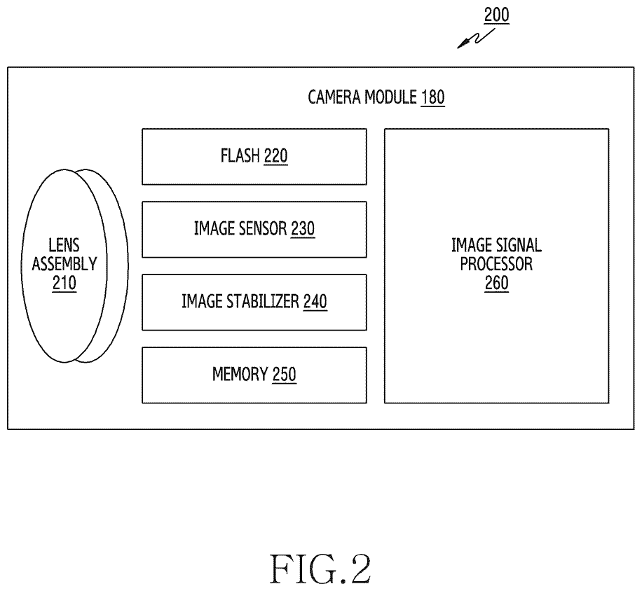

FIG. 2 is a block diagram 200 illustrating the camera module 180 according to an embodiment of the disclosure. Referring to FIG. 2, the camera module 180 may include a lens assembly 210, a flash 220, an image sensor 230, an image stabilizer 240, memory 250 (e.g., buffer memory), or an image signal processor 260. The lens assembly 210 may collect light emitted or reflected from an object whose image is to be taken. The lens assembly 210 may include one or more lenses. According to an embodiment, the camera module 180 may include a plurality of lens assemblies 210. In such a case, the camera module 180 may form, for example, a dual camera, a 360-degree camera, or a spherical camera. Some of the plurality of lens assemblies 210 may have the same lens attribute (e.g., view angle, focal length, auto-focusing, f number, or optical zoom), or at least one lens assembly may have one or more lens attributes different from those of another lens assembly. The lens assembly 210 may include, for example, a wide-angle lens or a telephoto lens.

The flash 220 may emit light that is used to reinforce light reflected from an object. According to an embodiment, the flash 220 may include one or more light emitting diodes (LEDs) (e.g., a red-green-blue (RGB) LED, a white LED, an infrared (IR) LED, or an ultraviolet (UV) LED) or a xenon lamp. The image sensor 230 may obtain an image corresponding to an object by converting light emitted or reflected from the object and transmitted via the lens assembly 210 into an electrical signal. According to an embodiment, the image sensor 230 may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor 230 may be implemented using, for example, a charged coupled device (CCD) sensor or a complementary metal oxide semiconductor (CMOS) sensor.

The image stabilizer 240 may move the image sensor 230 or at least one lens included in the lens assembly 210 in a particular direction, or control an operational attribute (e.g., adjust the read-out timing) of the image sensor 230 in response to the movement of the camera module 180 or the electronic device 101 including the camera module 180. This allows compensating for at least part of a negative effect (e.g., image blurring) by the movement on an image being captured. According to an embodiment, the image stabilizer 240 may sense such a movement by the camera module 180 or the electronic device 101 using a gyro sensor (not shown) or an acceleration sensor (not shown) disposed inside or outside the camera module 180. According to an embodiment, the image stabilizer 240 may be implemented, for example, as an optical image stabilizer.

The memory 250 may store, at least temporarily, at least part of an image obtained via the image sensor 230 for a subsequent image processing task. For example, if image capturing is delayed due to shutter lag or multiple images are quickly captured, a raw image obtained (e.g., a Bayer-patterned image, a high-resolution image) may be stored in the memory 250, and its corresponding copy image (e.g., a low-resolution image) may be previewed via the display module 160. Thereafter, if a specified condition is met (e.g., by a user's input or system command), at least part of the raw image stored in the memory 250 may be obtained and processed, for example, by the image signal processor 260. According to an embodiment, the memory 250 may be configured as at least part of the memory 130 or as a separate memory that is operated independently from the memory 130.

The image signal processor 260 may perform one or more image processing with respect to an image obtained via the image sensor 230 or an image stored in the memory 250. The one or more image processing may include, for example, depth map generation, three-dimensional (3D) modeling, panorama generation, feature point extraction, image synthesizing, or image compensation (e.g., noise reduction, resolution adjustment, brightness adjustment, blurring, sharpening, or softening). Additionally or alternatively, the image signal processor 260 may perform control (e.g., exposure time control or read-out timing control) with respect to at least one (e.g., the image sensor 230) of the components included in the camera module 180. An image processed by the image signal processor 260 may be stored back in the memory 250 for further processing, or may be provided to an external component (e.g., the memory 130, the display module 160, the electronic device 102, the electronic device 104, or the server 108) outside the camera module 180. According to an embodiment, the image signal processor 260 may be configured as at least part of the processor 120, or as a separate processor that is operated independently from the processor 120. If the image signal processor 260 is configured as a separate processor from the processor 120, at least one image processed by the image signal processor 260 may be displayed, by the processor 120, via the display module 160 as it is or after being further processed.

According to an embodiment, the electronic device 101 may include a plurality of camera modules 180 having different attributes or functions. In such a case, at least one of the plurality of camera modules 180 may form, for example, a wide-angle camera and at least another of the plurality of camera modules 180 may form a telephoto camera. Similarly, at least one of the plurality of camera modules 180 may form, for example, a front camera and at least another of the plurality of camera modules 180 may form a rear camera.

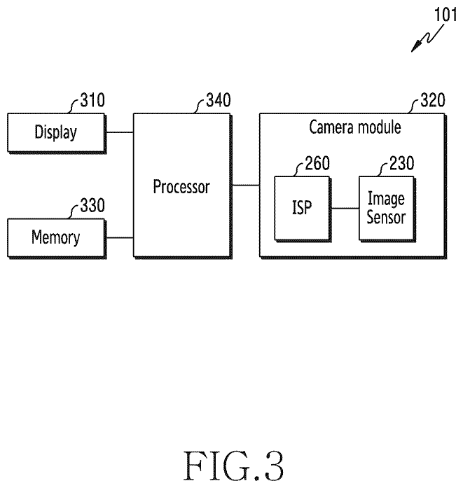

FIG. 3 is a block diagram of an electronic device according to an embodiment of the disclosure.

An electronic device 101 according to an embodiment may include a display 310 (e.g., the display module 160 of FIG. 1), a camera module 320 (e.g., the camera module 180 of FIG. 2), a memory 330 (e.g., the memory 130 of FIG. 1, the memory 250 of FIG. 2), and at least one processor 340 (e.g., the processor 120 of FIG. 1). The camera module 320 according to an embodiment may include an image sensor 230 and an image signal processor (ISP) 260. FIG. 3 is for explaining an embodiment, and some components of FIG. 3 may be omitted or replaced with other components.

The electronic device 101 according to an embodiment may execute a camera application for capturing an image. The camera application may support not only a basic mode in which all shooting settings are automatically determined based on a shooting environment but also a pro mode (or a manual mode) in which the shooting setting may be determined by a user setting. The electronic device 101 according to an embodiment may provide an interface capable of selecting strength (or a filter coefficient) of a neutral density (ND) filter in the pro mode along with intensity (ISO) of the image sensor 230, a shutter speed, and an exposure value (EV).

The electronic device 101 according to an embodiment may determine brightness of a preview and/or a system shooting time, based on the strength of the ND filter.

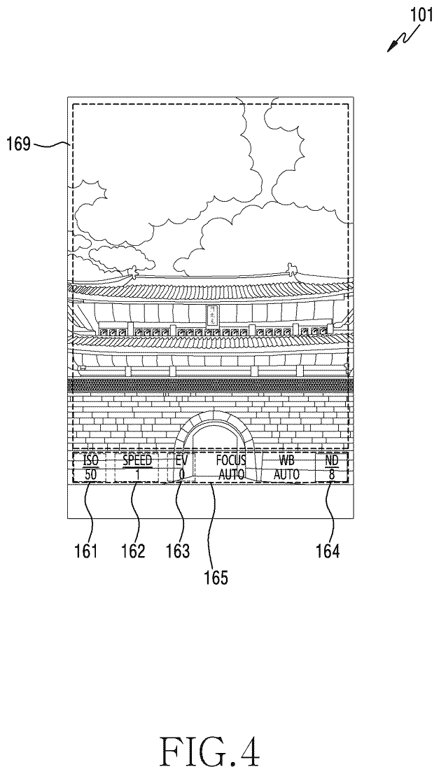

FIG. 4 illustrates a user interface displayed for an electronic device to provide an ND filter function according to an embodiment of the disclosure.

The electronic device 101 may obtain a plurality of short exposure images in a state where a shutter speed is set to be long (slow) and synthesize the plurality of short exposure images to obtain a long exposure image. The electronic device 101 has difficulty in obtaining the long exposure image in a relatively bright environment due to an excessive amount of light entering the image sensor 230. In this case, an ND filter may be used to adjust the amount of light in the bright environment. The ND filter mentioned herein is a physical device mountable on the electronic device 101, and shall be provided by a user separately from the electronic device 101.

Since the electronic device 101 is equipped with separate software capable of performing the ND filter function in the disclosure, the user may obtain the long exposure image in the bright environment without having to provide the separate physical device.

Referring to FIG. 4, the electronic device 101 according to an embodiment may provide a second set value 164 capable of selecting strength of the ND filter in a user interface provided when a shooting mode is executed. The shooting mode may be a pro mode (or a manual mode) in which not all shooting modes are determined automatically based on a shooting environment.

The electronic device 101 according to an embodiment may provide a shooting setting 165 including the second set value 164 capable of selecting strength (or a filter coefficient) of the ND filter in the pro mode along with sensitivity (ISO) 161 of the image sensor 230, a shutter speed 162, an EV 163. In addition to the aforementioned functions, the shooting setting 165 may include items such as a focus-auto function and a white balance (WB) function.

The electronic device 101 according to an embodiment may display a preview 169 on a real-time basis by using the display module 160 (see FIG. 1) along with the shooting setting 165. The preview may may be displayed on the display module 160 with a change on a real-time basis according to the shooting setting 165. For example, brightness of the preview 169 may be determined based on the EV 163.

The electronic device 101 according to an embodiment may display the second set value 164 as a numerical value corresponding to the strength of the ND filter through the display module 160. For example, the user may select any one of ND2, and ND4 to ND8 as the second set value 164 through the user interface. The greater the numerical value of the second set value 164, the more the light to be blocked may be. In an embodiment, the second set value 164 is not limited to the aforementioned example, and may include various numerical values (e.g., ND512, ND1000).

When the shutter speed is 1 second in a bright shooting environment, an image to be output as the preview may be oversaturated due to a high EV. In this case, when the second set value 164 proposed in the disclosure is set to a great value through a user input, the image to be output as the preview may be prevented from the oversaturation. In this case, not only a setting of a preview system which determines brightness of the preview but also a setting of a shooting system may be changed.

Meanwhile, in order to obtain a long exposure image, the electronic device 101 creates a plurality of short exposure images by varying a user-set shooting time and a system shooting time. In this case, another shooting set value (e.g., ISO) other than the user-set shooting time may be changed and used to obtain the short exposure image.

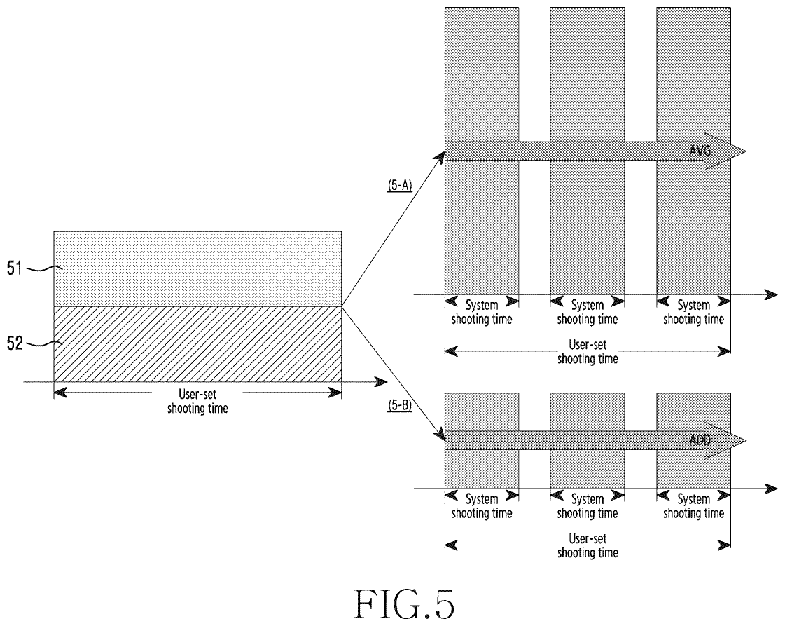

FIG. 5 is a drawing for explaining an operation of creating a long exposure image by using a short exposure image according to an embodiment of the disclosure.

For example, when an ND filter (a physical filter) is not mounted on a camera, a magnitude of an electronic signal converted using the image sensor 230 (see FIG. 3) may correspond to a sum of an area of a first region 51 and an area of a second region 52. In this case, when the ND filter is mounted to reduce an amount of light irradiated to the image sensor 230 by half, the magnitude of the electric signal converted using the image sensor 230 may correspond to the area of the second region 52.

Meanwhile, in an embodiment, the electronic device may use an ND filter algorithm instead of using the physical ND filter, thereby having an effect of substantially increasing an exposure time.

In an embodiment, the processor 120 may set a user-set shooting time which is a shutter speed, and a system shooting time, which is an exposure time for obtaining a short exposure image so as to be different from each other, and may synthesize the short exposure image obtained based on the system shooting time. A method of synthesizing the short exposure image may be roughly classified into two methods.

Referring to FIG. 5, in part (5-A), a long exposure image is created based an average of a plurality of short exposure images. In part (5-B), the long exposure image is created based on a sum for the plurality of short exposure images. In parts (5-A) and (5-B), an area per bar corresponds to the magnitude of the electronic signal converted by the image sensor 230.

In part (5-A), the area per bar corresponds to an area of the second region 52. This is because, when an image is obtained through a change in another shooting set value (e.g., ISO) other than the user-set shooting time, brightness of an image created in a state where a system shooting time is set to be short may be equal to brightness of an image created through the user-set shooting time.

In order to obtain the long exposure image according to part (5-A), a synthesis algorithm for motion, brightness, or the like may be added based on a method in which an average on pixel values of respective short exposure images is calculated, and all of the calculated average values are summed up.

In part (5-B), a sum of areas of three bars corresponds to a width of the second region 52. In order to obtain the long exposure image according to part (5-B), the synthesis algorithm for motion, brightness, or the like may be added based on a method in which pixel values of respective short exposure images are all summed up.

The processor 120 according to an embodiment may obtain a pixel value of a long exposure image, based on one of an average value, maximum value, minimum value, and mode value of pixels included in the respective short exposure images.

That is, the electronic device according to an embodiment may obtain a plurality of short exposure images during a user-set time (e.g., a shutter speed) and synthesize the obtained plurality of short exposure images, thereby providing a long exposure effect.

In order to obtain the long exposure image, the processor 120 according to an embodiment may use shake information of the electronic device 101 (see FIG. 1) and/or motion information of an object.

The electronic device 101 according to an embodiment may obtain the shake information of the electronic device 101. For example, as the shake information, the electronic device 101 may obtain user's heartbeat information, user's breathing information, and/or 3-dimensional acceleration information of the electronic device 101 while the plurality of short exposure images are obtained. The shake information may be used to select at least some of the plurality of short exposure images used to obtain the long exposure image. For example, the electronic device 101 may select a short exposure image obtained in a section in which a change in the user's heartbeat or breathing is less than or equal to a specific value. According to another example, the electronic device 101 may select a short exposure image obtained in a section in which a 3-dimentional acceleration value of the electronic device is less than or equal to a specific value. According to another example, the electronic device 101 may select at least some of the plurality of short exposure images by using an artificial intelligence model, based on the shake information.

When at least one of a plurality of short exposure images is selected based on the shake information of the electronic device, the processor 120 according to an embodiment may obtain motion information of an object included in the at least one short exposure image. The processor 120 may perform interpolation between the short exposure images, based on the motion information of the object. The processor 120 may synthesize the short exposure image subjected to the interpolation and the other short exposure images to obtain a long exposure image.

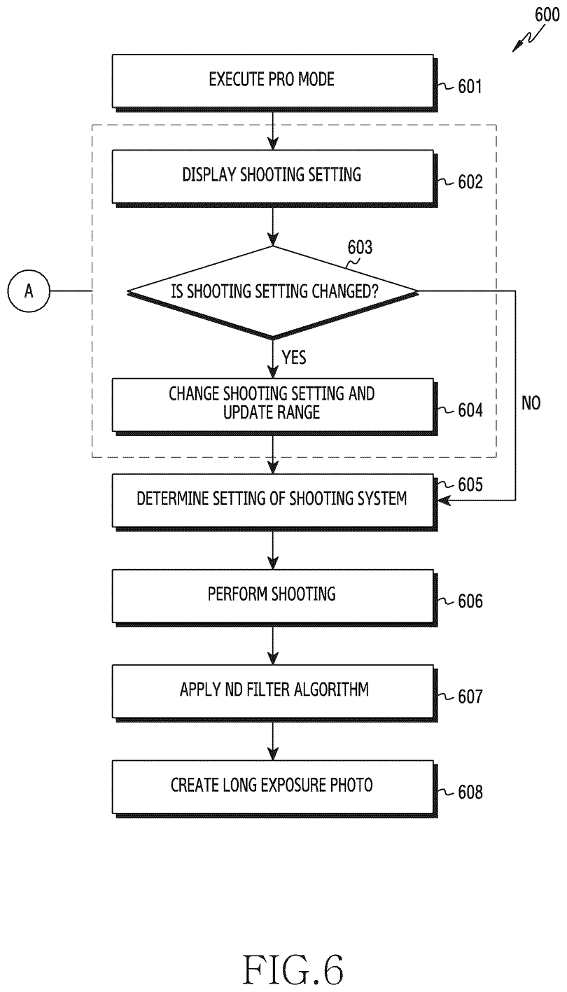

FIG. 6 is a flowchart 600 of an operation method in which the electronic device 101 (see FIG. 1) creates a long exposure photo according to an embodiment of the disclosure.

In operation 601, a pro mode is executed in the electronic device 101 according to an embodiment through user selection. The pro mode is one of shooting modes in which the electronic device 101 captures an image, and may provide a user interface which allows a user to directly select various shooting settings (e.g., sensitivity, shutter speed, etc.).

In operation 602, the electronic device 101 according to an embodiment may display the shooting setting through the display module 160. The shooting setting may provide the shooting setting 165 including the second set value capable of selecting strength (or a filter coefficient) of the ND filter along with the first set value including the ISO 161 of the image sensor, the shutter speed 162, and the EV 163. In addition to the aforementioned functions, the shooting setting may include items such as a focus-auto function and a WB function (see FIG. 4).

In operation 603, the electronic device 101 according to an embodiment detects whether the shooting setting is changed by the user input.

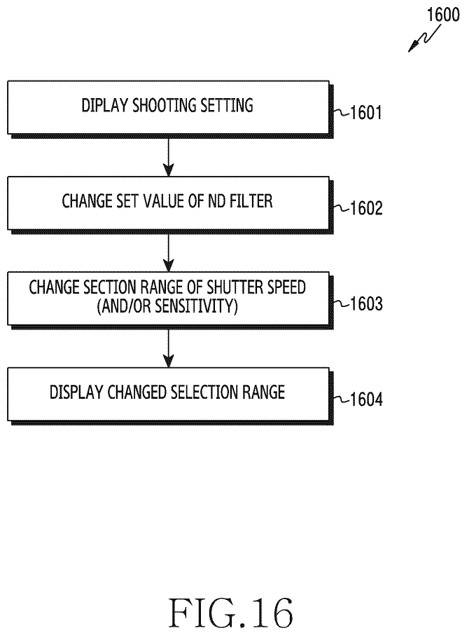

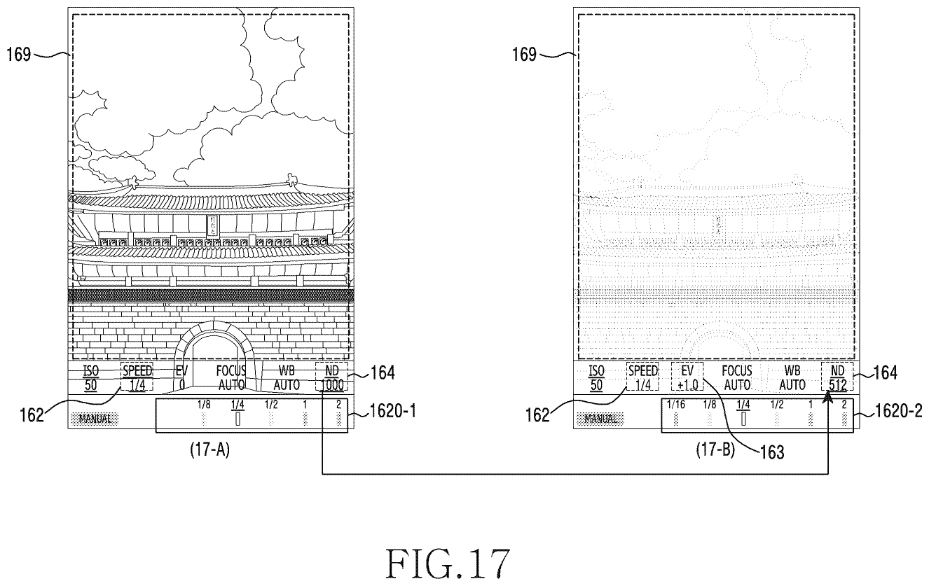

When it is detected that the shooting setting is changed by the user input, in operation 604, the electronic device 101 according to an embodiment may change the shooting setting and update a range. Herein, the range refers to a selection range of a shooting item selectable by the user among the remaining shooting items when any one of items of the shooting setting is changed by the user input. This will be described below with reference to FIGS. 16 and 17.

When there is no change in the shooting setting, the electronic device 101 according to an embodiment may determine a setting of a shooting system, based on the previously displayed shooting setting.

In operation 605, the electronic device 101 according to an embodiment determines the setting of the shooting system. The shooting system may determine an exposure time, sensitivity (ISO), or the like of a short exposure image so that the electronic device 101 obtains a long exposure image. In addition, the shooting system may determine a shooting count of the short exposure image to obtain the long exposure image. The shooting system may determine the exposure time and/or the ISO and/or the shooting count, based on a shooting environment and/or strength of an ND filter selected by the user. When the user determines a user-set shooting time (shutter speed), the shooting system may determine an exposure time for obtaining the short exposure image in consideration of the shooting environment. The exposure time is a system shooting time. In order to perform an ND filter function, the system shooting time is set to a shorter time than a user-set shooting time. If the ND filter function is not enabled, the system shooting time may be equal to the user-set shooting time.

In operation 606, the electronic device 101 according to an embodiment performs shooting in response to a user input. In operation 607, the electronic device 101 according to an embodiment applies an ND filter algorithm. The ND filter algorithm includes an operation of determining a shooting count and exposure time of the short exposure image by the shooting system. The shooting count and the exposure time may be determined based on a shooting environment of the electronic device 101.

In operation 608, the electronic device 101 according to an embodiment creates a long exposure photo (a long exposure image). The electronic device 101 may synthetize a plurality of short exposure images created in the operation 607 to create the long exposure image. The long exposure images may be synthesized in reference to parts (5-A) and (5-B) described in FIG. 5.

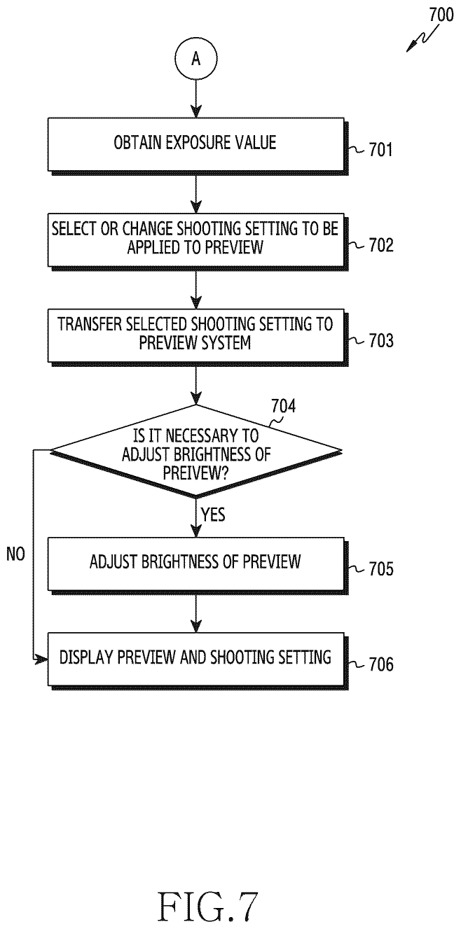

Meanwhile, apart from creating and storing the long exposure image, the electronic device may determine brightness of a preview, based on the strength of the ND filter selected by the user. For example, when the user changes the shooting setting irrespective of the exposure time determined by the shooting system, the electronic device 101 may determine the brightness of the preview, based on values for the changed shooting setting. An embodiment for adjusting the brightness of the preview will be described with reference to FIG. 7.

FIG. 7 is a flowchart 700 of an operation method in which an electronic device changes a preview and a shooting setting according to an embodiment of the disclosure.

In the embodiment, the preview is a preview image which shows a long exposure image to be created by an ND filter algorithm, and may be displayed along with the shooting setting through the display module 160. However, the preview may not be the same as the long exposure image or a short exposure image. A user may predict what kind of long exposure image will be output through the preview, or may verify only a brightness difference between a shooting setting currently being output and a changed shooting setting through the preview.

The shooting setting provided along with the preview may be any one of a shooting setting previously set by the user and a value obtained by analyzing a current shooting environment.

In operation 701, the electronic device 101 according to an embodiment may obtain an EV. For example, the EV is a value specified by a combination of a shutter speed, ISO, or the like (an aperture value), and may represent brightness of a resultant object captured through the camera module 180. A process of calculating the EV may refer to a standard for additive system of photographic exposure (APEX), and a detailed description thereof will be omitted since it is a previously announced method. The EV may be calculated based on brightness of an image consequently obtained by an actual user through the entire value of the shooting setting.

In operation 702, the electronic device 101 according to an embodiment may select the shooting setting to be applied to the preview, and may determine a value thereof. For example, assuming that the shutter speed, the sensitivity, and the strength of the ND filter are the entire shooting setting of the electronic device 101, the shutter speed and the sensitivity may be selected to obtain the preview, and the shutter speed and the sensitivity value may be determined by considering the calculated EV.

In addition, in response to changing the shooting setting by the user, the electronic device 101 according to an embodiment may transfer to a preview system a shooting set value changed by the user.

In operation 703, the electronic device 101 according to an embodiment may transfer to the preview system the selected (or changed) shooting set value. The preview system determines brightness of the preview which is output on the display module 160 on a real-time basis, and is not involved in an exposure time and shooting count determined by a shooting system.

In operation 704, the electronic device 101 according to an embodiment may determine whether there is a need to adjust the brightness of the preview.

If the EV obtained in operation 701 and an image obtained in the preview system are different in brightness (Yes in the operation 704), the electronic device 101 according to an embodiment may adjust the brightness of the preview through image processing in operation 705.

If there is no brightness difference between the EV obtained in operation 701 and the image obtained in the preview system and thus it is not necessary to adjust the brightness of the preview (No in the operation 704), the electronic device 101 according to an embodiment may display, without alternation, the existing preview and the existing shooting setting.

If the strength of the ND filter is adjusted by a user input in a state where a setting option for the shutter speed and sensitivity is the auto mode, it is not necessary to adjust the brightness of the preview since the EV is automatically set to 0. On the contrary, when the strength of the ND filter is adjusted by the user input in a state where the setting option for the shutter speed and sensitivity is the manual mode, the brightness of the preview may be changed. For example, when the user increases the strength of the ND filter, the preview becomes relatively dark. When the strength of the ND filter is increased, the shooting settings of the shooting system may be suitable for obtaining a long exposure image, but may not be suitable for the user to identify an image on a real-time basis through the preview. Therefore, when there is a great difference between the shooting setting of the shooting system and the shooting setting of the preview system, the electronic device 101 according to the embodiment may automatically change the shooting setting (shutter speed and/or sensitivity) of the preview system, or may adjust the brightness of the preview itself through image processing.

When the shooting mode is the pro mode and the EV is defined in the range of −2.0 to +2.0, a most suitable EV may correspond to 0. For example, when the shutter speed is set to 1/100 and the sensitivity is set to 100, the EV may be +1.0. When the EV is +1.0, the preview displayed on the display module 160 may have relatively high brightness. In this case, the preview system may automatically change the shooting setting, or may adjust only the brightness of the preview without alternation of the shooting setting.

When there is a need to adjust the brightness of the preview, the electronic device 101 according to an embodiment may automatically change the shooting setting. For example, the electronic device 101 may change the shutter speed to 1/50 (the sensitivity is 100 without change), or may change the sensitivity to 200 (the shutter speed is 1/100 without change), in a state where the EV is +1 (shutter speed: 1/100, sensitivity: 100).

When there is a need to adjust the brightness of the preview, the electronic device 101 according to an embodiment may change the brightness of the preview itself. The electronic device 101 according to the embodiment may adjust the brightness itself of the image recognized by the user through image processing, without alternation of the shooting setting.

If shooting set values of the shooting system are equal to shooting set values of the preview system, the electronic device 101 may not adjust the brightness of the preview.

In operation 706, the electronic device 101 according to an embodiment displays the preview and the (changed) shooting setting through the display module 160.

When at least one first set value including the shutter speed (and/or sensitivity) is changed by the user input, the electronic device 101 according to an embodiment may obtain the EV, and may adjust the brightness of the preview, based on the EV and a second set value which is the strength of the ND filter.

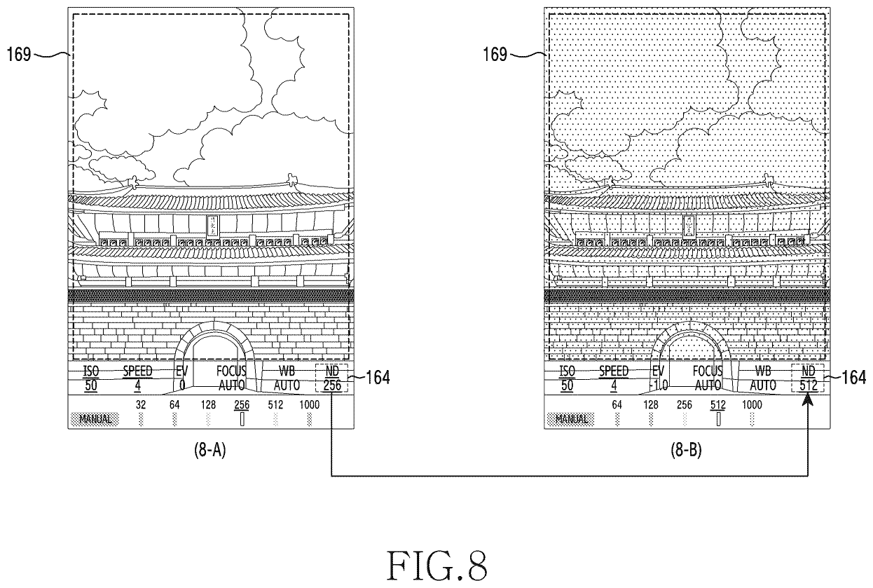

FIG. 8 is a drawing for explaining a change in brightness of the preview 169 when strength of an ND filter is adjusted in an electronic device according to an embodiment of the disclosure.

Part (8-A) of FIG. 8 shows a state where a user adjusts a shutter speed, sensitivity, and strength of the ND filter, and thus an Exposure value (EV) becomes 0. In an embodiment, a maximum value of the strength (the second set value 164) which may be selected by the user through the electronic device 101 (see FIG. 1) may be restricted to 1000. The electronic device 101 may automatically change the EV and/or brightness of the preview 169 whenever there is a change in the strength of the ND filter.

Part (8-B) of FIG. 8 shows a state where the user increases the strength of the ND filter by double through the electronic device 101. Since only the strength of the ND filter increases from 256 to 512 in a state where a value (a shutter speed and sensitivity) for another shooting setting is fixed, the EV is calculated to be −1.0, and it is shown that the brightness of the preview 169 is darker compared to (8-A).

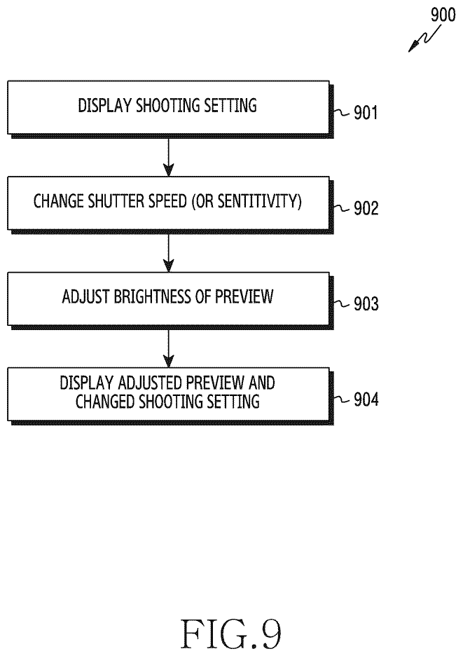

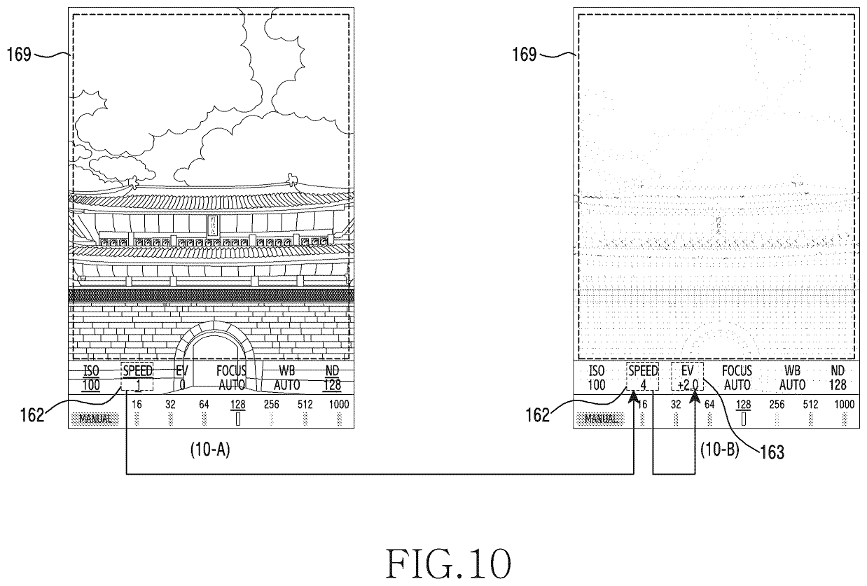

FIG. 9 is a flowchart 900 of an operation method in which a shooting setting and brightness of a preview change when a first set value is adjusted in an electronic device according to an embodiment of the disclosure. FIG. 10 is a drawing to be referred to in the operation method according to FIG. 9 according to an embodiment of the disclosure.

In operation 901, the electronic device 101 according to an embodiment displays a shooting setting through the display module 160. Referring to part (10-A) of FIG. 10 together, it is a state where the shutter speed 162 is set to 1 in the shooting setting of the electronic device 101. In this case, the electronic device 101 may calculate an EV to be 0, based on at least one of a shutter speed value of 1, a sensitivity value of 100, and an ND filter strength of 128, and may display the EV through the display module 160 (see FIG. 1).

In operation 902, the shutter speed (or sensitivity) of the electronic device 101 according to an embodiment may be changed by a user input. Referring to parts (10-A) and (10-B) of FIG. 10, it is a state where the shutter speed has been changed from 1 to 4 by the user input.

In operation 903, the electronic device 101 according to an embodiment adjusts brightness of a preview. Due to an increase in the shutter speed by 4 times, the EV 163 is determined to be +2. The electronic device 101 may adjust the brightness of the preview according to the EV, based on a shooting set value and/or image processing.

In operation 904, the electronic device 101 according to an embodiment displays the adjusted preview and the changed shooting setting. Referring to part (10-B) of FIG. 10, the brightness of the preview 169 is adjusted to be brighter than that in part (10-A) of FIG. 10 since the EV 163 is determined to be +2. The brightness of the preview 169 according to FIG. 10 may be rendered with reference to the process of FIG. 7.

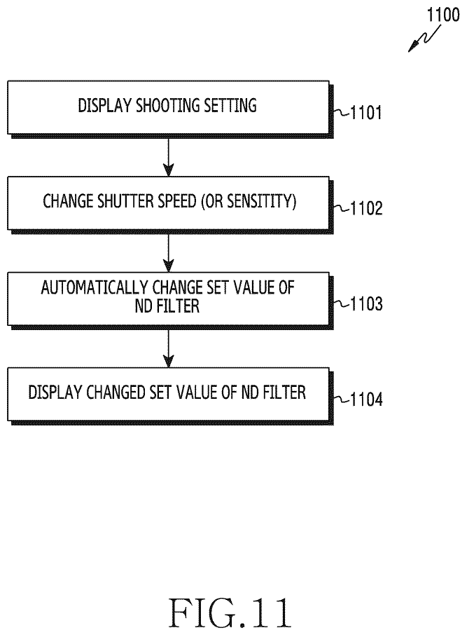

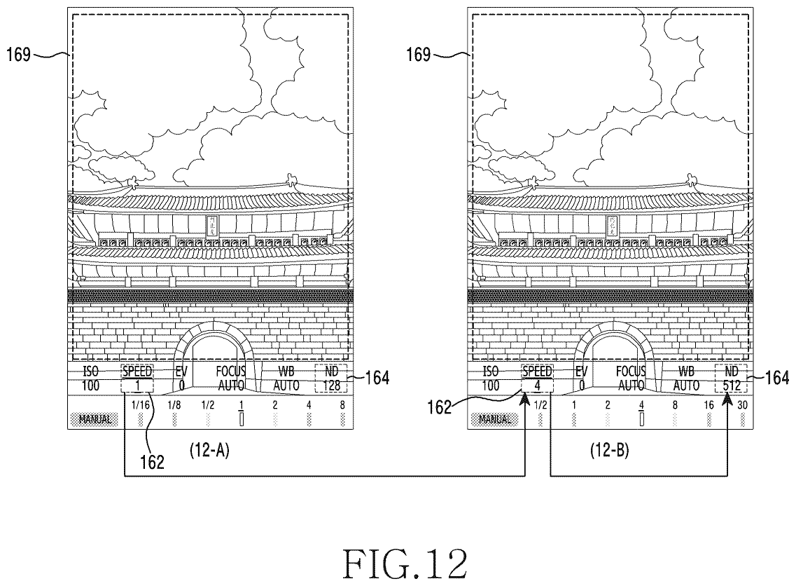

FIG. 11 is a flowchart 1100 of an operation method in which a set value of an ND filter changes when a first set value is adjusted in an electronic device according to an embodiment of the disclosure. FIG. 12 is a drawing to be referred to in the operation method according to FIG. 11 according to an embodiment of the disclosure.

In operation 1101, the electronic device 101 according to an embodiment displays a shooting setting through the display module 160. Referring to part (12-A) of FIG. 12 together, it is a state where the shutter speed 162 is set to 1 in the shooting setting of the electronic device 101. In this case, the electronic device 101 may calculate an EV to be 0, based on a shutter speed value of 1 and a sensitivity value of 100, and may display the EV through the display module 160 (see FIG. 1).

In operation 1102, the shutter speed (or sensitivity) of the electronic device 101 according to an embodiment may be changed by a user input. Referring to parts (12-A) and (12-B) of FIG. 12, it is a state where the shutter speed has been changed from 1 to 4 by the user input. Considering only an increase in the shutter speed 162, the preview 169 will become relatively bright.

In an embodiment according to FIG. 12, there is no change in the brightness of the preview 169 even if the shutter speed is increased by the user input unlike in FIG. 10 described above. The brightness of the preview 169 does not change because the electronic device 101 according to an embodiment automatically changes the set value 164 of the ND filter in accordance with the change in the shutter speed in operation 1103. Referring to parts (12-A) and (12-B) of FIG. 12, the electronic device 101 may change the set value 164 of the ND filter from 128 to 512 in compensation for maintaining a proper EV even if the shutter speed increases.

In operation 1104, the electronic device 101 according to an embodiment displays the changed set value of the ND filter through the display module 160.

To summarize an embodiment according to FIG. 11, in order to properly maintain the brightness and/or EV of the preview, the electronic device 101 automatically changes the set value of the ND filter in accordance with a change in the shutter speed (or sensitivity) by a user input.

The electronic device 101 according to an embodiment may automatically change the second set value which determines the strength of the ND filter, when at least one first set value which determines the shutter speed (and/or sensitivity) is changed by the user input. The electronic device 101 may display the shooting setting including the changed first and second set values through the display module 160 along with the preview.

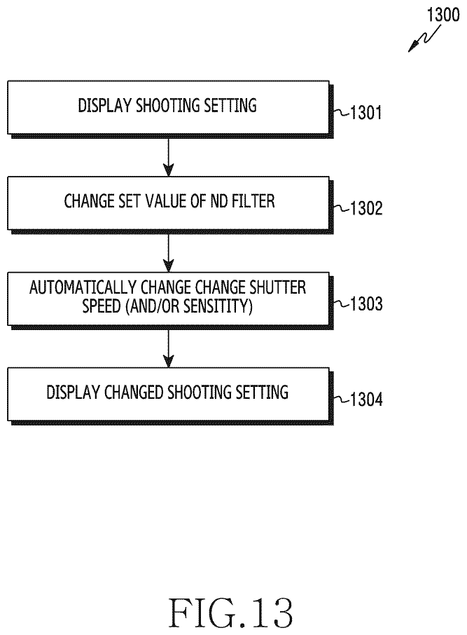

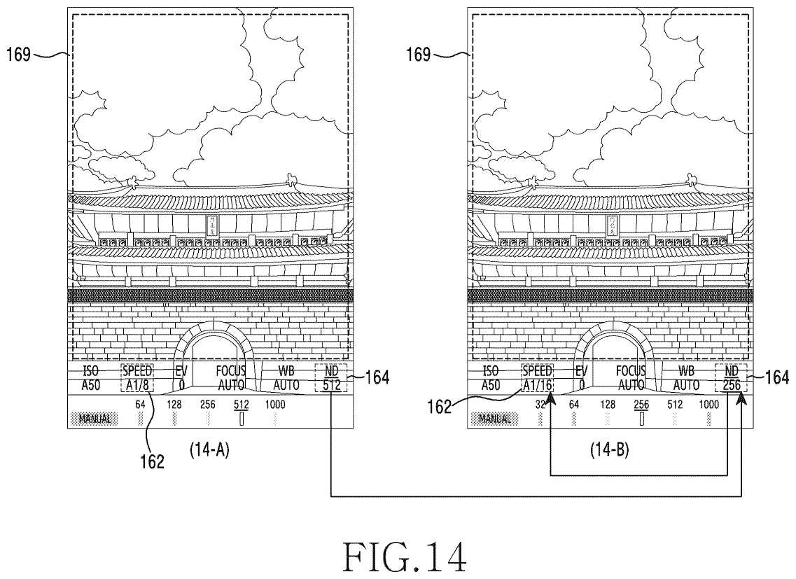

As described above, the brightness of the preview may vary based on the set value of the ND filter in addition to the shutter speed or the sensitivity. This will be described with reference to FIGS. 13 and 14.

FIG. 13 is a flowchart 1300 of an operation method in which a first set value changes when a set value of an ND filter is adjusted in an electronic device according to an embodiment of the disclosure. FIG. 14 is a drawing to be referred to in the operation method according to FIG. 13 according to an embodiment of the disclosure.

In operation 1301, the electronic device 101 according to an embodiment displays a shooting setting through the display module 160. Referring to part (14-A) of FIG. 14 together, it is a state where the shutter speed 162 is set to ⅛ in the shooting setting of the electronic device 101. In this case, the electronic device 101 may calculate an EV to be 0, based on a shutter speed value of ⅛ and a sensitivity value of 50, and may display the EV through the display module 160 (see FIG. 1).

In operation 1302, the set value 164 of the ND filter of the electronic device 101 according to an embodiment may be changed by a user input. Referring to parts (14-A) and (14-B) of FIG. 14, it is a state where the set value of the ND filter has been changed from 512 to 256. Considering only a decrease in the set value 164, the preview 169 will become relatively bright.

In operation 1303, in an embodiment according to FIG. 14, there is no change in the brightness of the preview 169 even if the set value 164 of the ND filter is changed by the user input similarly to FIG. 12 described above. The brightness of the preview 169 does not change because the electronic device 101 according to an embodiment automatically changes the set value of the shutter speed (or sensitivity) in accordance with the change in the set value 164 of the ND filter in the operation 1303. Referring to parts (14-A) and (14-B) of FIG. 14, the electronic device 101 may change the set value of the shutter speed 162 from ⅛ to 1/16 in compensation for maintaining a proper EV even if the set value 164 of the ND filter decreases.

In operation 1304, the electronic device 101 according to an embodiment displays the changed shooting setting through the display module 160. For example, the electronic device 101 changes the set value of the shutter speed (or sensitivity) when the set value of the ND filter is changed by the user input, and displays the changed set value through the display module 160 so as to be recognizable by the user.

When a setting option for a first set value which determines the shutter speed and/or the sensitivity is set to an auto mode, the electronic device 101 according to an embodiment may automatically change the first set value in response to changing the set value of the ND filter by the user input. The electronic device 101 may automatically adjust the shutter speed and/or the sensitivity in order to compensate for the change in the set value of the ND filter to maintain the EV at a proper level of 0. Since the electronic device 101 always maintains the EV at 0, the brightness of the preview 169 remains to be the same.

The electronic device 101 according to an embodiment may automatically change at least one first set value which determines the shutter speed (and/or sensitivity), when a second set value which determines the strength of the ND filter is changed by the user input. The electronic device 101 may display the shooting setting including the changed first and second set values through the display module 160 along with the preview.

The electronic device 101 according to an embodiment may increase the set value of the shutter speed in response to changing the second set value which determines the strength of the ND filter by the user input, and may decrease the set value of the shutter speed in response to decreasing the second set value by the user input.

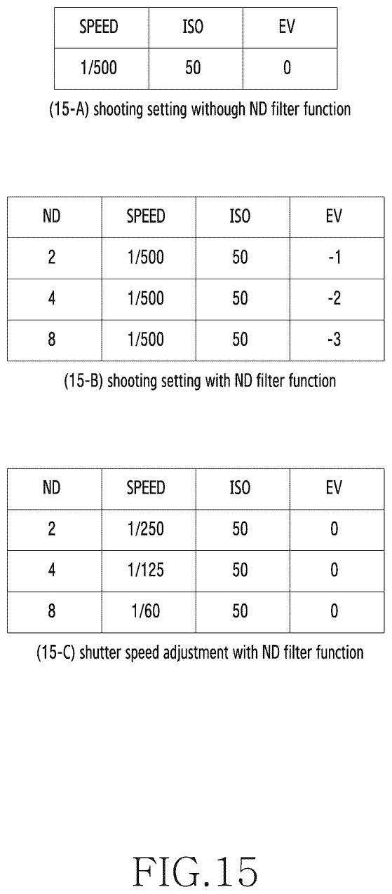

FIG. 15 illustrates examples of a shooting setting based on whether an ND filter function is present or absent according to an embodiment of the disclosure.

It is shown in FIG. 15 that a long exposure time (a shutter speed) may be secured in the shooting environment (the same brightness) as the existing environment, by adjusting strength of an ND filter.

Part (15-A) of FIG. 15 shows a case where an EV is 0, when a shutter speed is 1/500 and ISO is 50, as a default initial value of a shooting setting. However, each of numerical values of FIG. 15 is only one example for facilitating understanding, and it is obvious that more various numerical values may be used based on various specifications of the electronic device 101.

Part (15-B) of FIG. 15 shows that the EV decreases to −1, −2, or −3, when the strength of the ND filter increases to 2, 4, or 8 in a state where the shutter speed and the ISO are fixed. That is, the EV decreases in proportion to an increase in the strength of the ND filter in the state where the shutter speed and the ISO are fixed.

Referring to part (15-C) of FIG. 15, it is shown that the EV is 0 when the electronic device 101 increases the shutter speed by double for a proper exposure in part (15-B) of FIG. 15. The disclosure allows a user to obtain an optimal long exposure image through such interaction. For example, the EV may be maintained at 0 to induce an increase in the shutter speed, and an exposure time of a shooting system may be secured to be longer than the existing one.

Meanwhile, various embodiments described with reference to FIGS. 11 to 15 may automatically adjust the set value of the ND filter in response to changing the shutter speed (and/or sensitivity) by the user input, or may automatically adjust the set value of the shutter speed (and/or sensitivity) in response to changing the set value of the ND filter by the user input. The electronic device 101 may automatically change each set value in an auto mode or a manual mode.

When the setting option for the set value is the manual mode, the electronic device 101 may provide a selection range so that the user selects a specific set value. For example, the electronic device 101 may provide a selection range of a shutter speed having an interval of 1/12000 to 30 in the manual mode. In addition, the electronic device 101 may provide a selection range of a shutter speed having an interval of 50 to 3200 in the manual mode. In addition, the electronic device 101 may provide a selection range for strength of an ND filter having an interval of 1 to 1000 in the manual mode.

When the selection range for the set value is provided in the manual mode, the electronic device 101 may provide a selection range for another set value variably by considering any one set value selected in advance so that the user obtains a long exposure photo, based on a proper exposure time. A specific process is described with reference to FIGS. 16 and 17.

FIG. 16 is a flowchart 1600 of an operation method in which a setting range of a first set value changes when a set value of an ND filter is adjusted in an electronic device according to an embodiment of the disclosure. FIG. 17 is a drawing to be referred to in the operation method according to FIG. 16 according to an embodiment of the disclosure.

In operation 1601, the electronic device 101 according to an embodiment displays a shooting setting through the display module 160. In the embodiment, the electronic device 101 displays a selection range for the shutter speed through the display module 160 along with the shooting setting. Referring to part (17-A) of FIG. 17, a first selection range 1620-1 of the shutter speed 162 is displayed on the display module 160 along with the shooting setting. The first selection range 1602-1 includes a plurality of selection values.

For example, ⅛, ¼, ½, 1, and 2 are provided in the first selection range 1620-1 of the shutter speed of part (17-A) of FIG. 17 as the plurality of selection values. The first selection range 1620-1 may include the plurality of selection values for the shutter speed so that a proper exposure time is determined when the set value 164 of the ND filter is 1000.

In operation 1602, the set value 164 of the ND filter of the electronic device 101 according to an embodiment may be changed by a user input. Referring to parts (17-A) and (17-B) of FIG. 17, it is a state where the set value of the ND filter has been changed from 1000 to 512. The change in the set value of the ND filter results in a change in an EV from 0 to +1.0. Brightness of the preview 169 may be adjusted in response to determining the EV 163 to be +1.0. In operation 1603, the electronic device 101 according to an embodiment may change a selection range of a shutter speed (and/or sensitivity) (see operation 1603). The change in the selection range is based on the change in the set value of the ND filter in the operation 1602. Referring to parts (17-A) and (17-B) of FIG. 17, it is shown that the selection range of the shutter speed changes from a first selection range 1620-1 to a second selection range 1620-2 with a change in the set value of the ND filter from 1000 to 512. When the set value of the ND filter is 1000, a minimum selection value of the shutter speed selectable by the user is ⅛, whereas with the change in the set value of the ND filter to 512, the minimum selection value of the shutter speed selectable by the user is 1/16, which shows that the selection range is further widened.

In operation 1604, the electronic device 101 according to an embodiment displays the changed selection range through the display. For example, in response to changing the set value of the ND filter, the electronic device 101 according to an embodiment may change the selection range of the shutter speed from the first selection range 1620-1 to the second selection range 1620-2. The electronic device 101 according to an embodiment may be configured to, when a second set value which is the strength of the ND filter is first strength, display a first selection range corresponding to the first set value on the display module 160 in response to detecting a user input for selecting at least one first set value including the shutter speed (and/or sensitivity), detect a change in the second set value from the first strength to second strength by the user input, and when the second set value is the second strength, display a second selection range corresponding to the first set value on the display module 160 in response to detecting the user input for selecting the first set value.

An embodiment described with reference to FIGS. 16 and 17 refers to an operation in which the selection range of the shutter speed (and/or shutter) changes based on a change in the set value of the ND filter. However, according to the same principle, the selection range of the ND filter may change based on a change in the set value of the shutter speed (and/or sensitivity).

The electronic device 101 according to an embodiment may be configured to, when the at least one first set value including the shutter speed (and/or sensitivity) is a first value, display the first strength selection range corresponding to the second set value on the display module 160 in response to detecting a user input for selecting the second set value which is the strength of the ND filter, detect a change in the first set value from the first value to a second value by the user input, and when the first set value is the second value, display a second strength selection range corresponding to the second set value on the display module 160 in response to detecting the user input for selecting the second set value.

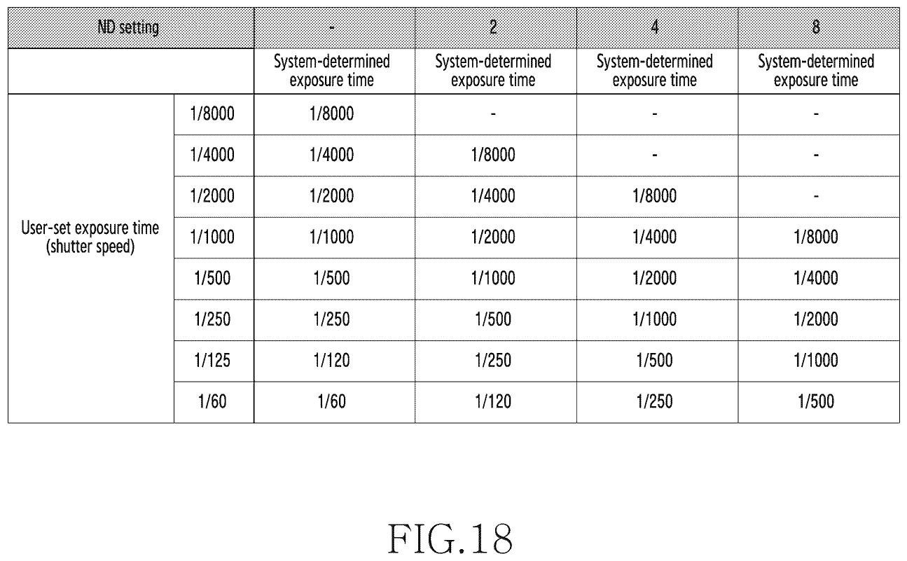

FIG. 18 illustrates examples in which a shutter speed is restricted based on a set value of an ND filter according to an embodiment of the disclosure.

FIG. 18 shows a level of restricting an exposure time (the shutter speed) which is one of shooting settings selectable by a user according to the set value (strength) of the ND filter. When an ND filter function is not enabled, a minimum value of an exposure time provided by a shooting system of the electronic device 101 is 1/8000. That is, a minimum value of a shutter speed selectable by the user in a state where the ND filter function is not enabled is 1/8000. In this case, when the user sets the shutter speed to 1/8000, the shooting system also sets the exposure time to 1/8000 to obtain an image.

Unlike this, in the state where the ND filter function is enabled, the shutter speed set by the user and the exposure time determined by the shooting system are different from each other. For example, when the user sets the strength of the ND filter to 2, the minimum value of the shutter speed selectable by the user changes from 1/8000 to 1/4000, thereby decreasing a range of the shutter speed selectable by the user.

The electronic device 101 according to an embodiment decreases the range of the shutter speed selectable by the user in proportion to an increase in the strength of the ND filter. When the strength of the ND filter has a value other than 0, the electronic device 101 sets the exposure time (the shutter speed) set by the user and the exposure time determined by the shooting system to be different from each other since a plurality of images with a shorter time than the exposure time (the shutter speed) set by the user shall be obtained and synthesized.

For example, when the user is allowed to set the strength of the ND filter to 2 and to select the shutter speed to 1/8000, the shooting system has to use an exposure time shorter than 1/8000 to obtain at least two images, which is beyond a limit of the shooting system (a minimum exposure time of the shooting system: 1/8000). Therefore, the electronic device 101 according to the embodiment may induce the user to obtain an optimal long exposure image by restricting the range of the shutter speed provided to the user.

When the user sets the strength of the ND filter to a great value, it is predictable that a selection range of the shutter speed selectable by the user is decreased. If the user intends to change a set value of the ND filter to further increase the shutter speed, the electronic device 101 may automatically disable the ND filter function.

The electronic device 101 according to an embodiment determines the exposure time of the shooting system, based on the shutter speed and the strength of the ND filter. When a difference between the minimum value of the exposure time and the minimum value of the shutter speed is greater than or equal to a predetermined numerical value, the electronic device 101 may restrict a change in the second set value which is the strength of the ND filter.

Additionally, the electronic device 101 may further include an illumination detection module (e.g., the sensor module 176 of FIG. 1) to automatically enable the function of the ND filter in consideration of an ambient environment of the electronic device 101. According to an embodiment, the electronic device 101 may further include the illumination detection module which outputs a signal for measuring ambient brightness. In addition, the aforementioned illumination detection module may be implemented by analyzing an image obtained from the image sensor through the first set value. The electronic device 101 may adaptively display the second set value which is the strength of the ND filter on the display module 160, based on the signal obtained from the illumination sensor. For example, the electronic device 101 may display the second set value through the display module 160 only when the illumination is greater than or equal to a pre-set value.

An electronic device (e.g., the electronic device 101 of FIGS. 1 and 3) according to an embodiment may include a display (e.g., the display module 160 of FIG. 1, the display 310 of FIG. 3) which provides a preview, a camera (e.g., the camera module 180 of FIGS. 1 and 2) including an image sensor (e.g., the image sensor 230 of FIGS. 2 and 3), a memory (e.g., the memory 130 of FIG. 1, the memory 250 of FIG. 2, the memory 330 of FIG. 3) which stores instructions, and at least one processor (e.g., the processor 120 of FIG. 1, the processor 340 of FIG. 3).

The at least one processor (e.g., the processor 120 of FIG. 1, the processor 340 of FIG. 3) according to an embodiment may execute instructions stored in the memory (e.g., the memory 130 of FIG. 1, the memory 250 of FIG. 2, the memory 330 of FIG. 3).

The at least one processor (e.g., the processor 120 of FIG. 1, the processor 340 of FIG. 3) according to an embodiment may display a shooting setting including at least one first set value and a second set value through the display (e.g., the display module 160 of FIG. 1, the display 310 of FIG. 3).

The at least one processor (e.g., the processor 120 of FIG. 1, the processor 340 of FIG. 3) according to an embodiment may change the at least one first set value which determines a shutter speed when the second set value which determines strength of a ND filter is changed by a user input.

The at least one processor (e.g., the processor 120 of FIG. 1, the processor 340 of FIG. 3) according to an embodiment may display the changed shooting setting through the display (e.g., the display module 160 of FIG. 1, the display 310 of FIG. 3) along with the preview.

The at least one processor (e.g., the processor 120 of FIG. 1, the processor 340 of FIG. 3) according to an embodiment may change the second set value when the at least one first set value is changed by the user input.

The at least one first set value of the electronic device (e.g., the electronic device 101 of FIGS. 1 and 3) according to an embodiment may include the shutter speed and sensitivity (ISO) of the image sensor.

The at least one processor (e.g., the processor 120 of FIG. 1, the processor 340 of FIG. 3) according to an embodiment may determine an exposure value, based on the shutter speed and the sensitivity, and may display the exposure value through the display (e.g., the display module 160 of FIG. 1, the display 310 of FIG. 3).

The at least one processor (e.g., the processor 120 of FIG. 1, the processor 340 of FIG. 3) according to an embodiment may obtain the exposure value when the at least one first set value is changed by the user input, and may adjust brightness of the preview, based on the exposure value and the second set value.

The at least one processor (e.g., the processor 120 of FIG. 1, the processor 340 of FIG. 3) according to an embodiment may increase a set value of the shutter speed when the second set value increases based on the user input, and may decrease the set value of the shutter speed when the second set value decreases based on the user input.

The at least one processor (e.g., the processor 120 of FIG. 1, the processor 340 of FIG. 3) according to an embodiment may be configured to, when the second set value is first strength, display a first selection range corresponding to the first set value on the display in response to detecting a user input for selecting the first set value, detect that the second set value is changed from the first strength to second strength by the user input, and when the second set value is the second strength, display a second selection range corresponding to the first set value on the display (e.g., the display module 160 of FIG. 1, the display 310 of FIG. 3) in response to detecting the user input for selecting the first set value.

The at least one processor (e.g., the processor 120 of FIG. 1, the processor 340 of FIG. 3) according to an embodiment may be configured to, when the first set value is a first value, display a first strength selection range corresponding to the second set value on the display in response to detecting a user input for selecting the second set value, detect that the first set value is changed from the first value to a second value by the user input, and when the first set value is the second value, display a second strength selection range corresponding to the second set value on the display (e.g., the display module 160 of FIG. 1, the display 310 of FIG. 3) in response to detecting the user input for selecting the second set value.

The at least one processor (e.g., the processor 120 of FIG. 1, the processor 340 of FIG. 3) according to an embodiment may determine an exposure time of a shooting system, based on the shutter speed and the strength of the ND filter.

The at least one processor (e.g., the processor 120 of FIG. 1, the processor 340 of FIG. 3) according to an embodiment may restrict a change in the second set value, when a difference between a minimum value of the exposure time and a minimum value of the shutter speed is greater than or equal to a predetermined numerical value.

The electronic device (e.g., the electronic device 101 of FIGS. 1 and 3) according to an embodiment may further include an illumination sensor which outputs a signal for measuring illumination around the electronic device.

The at least one processor (e.g., the processor 120 of FIG. 1, the processor 340 of FIG. 3) according to an embodiment may display the second set value adaptively on the display (e.g., the display module 160 of FIG. 1, the display 310 of FIG. 3), based on a signal obtained from the illumination sensor.

The at least one processor (e.g., the processor 120 of FIG. 1, the processor 340 of FIG. 3) according to an embodiment may determine an exposure time of a shooting system, based on the strength of the ND filter selected based on the user input, and may obtain a plurality of short exposure images, based on the exposure time and the shutter speed selected based on the user input.

The at least one processor (e.g., the processor 120 of FIG. 1, the processor 340 of FIG. 3) according to an embodiment may align the plurality of short exposure images, based on shake information of the electronic device (e.g., the electronic device 101 of FIGS. 1 and 3) and/or motion information of an object included in the short exposure image, and may obtain a long exposure image by synthesizing the aligned plurality of short exposure images.

Advantages acquired in the disclosure are not limited to the aforementioned advantages, and other advantages not mentioned herein may be clearly understood by those skilled in the art to which the disclosure pertains from the following descriptions.

Methods based on the embodiments disclosed in the claims and/or specification of the disclosure may be implemented in hardware, software, or a combination of both.

When implemented in software, a computer readable recording medium for storing one or more programs (i.e., software modules) may be provided. The one or more programs stored in the computer readable recording medium are configured for execution performed by one or more processors in the electronic device. The one or more programs include instructions for allowing the electronic device to execute the methods based on the embodiments disclosed in the claims and/or specification of the disclosure.

In the disclosure, programs (e.g., software modules or software) may be stored in a random access memory and/or a non-volatile memory including a flash memory, a read only memory (ROM), an electrically erasable programmable read only memory (EEPROM), a magnetic disc storage device, a compact disc-ROM (CD-ROM), digital versatile discs (DVDs), other forms of optical storage devices, or a magnetic cassette. Alternatively, the programs may be stored in a memory configured in combination of all or some of these storage media. The memory may be constructed of a single storage medium or a combination of a plurality of storage media. The at least one instruction may be stored in the single storage medium, or may be stored in the plurality of storage media in a distributed manner.

Further, the program may be stored in an attachable storage device capable of accessing the electronic device through a communication network such as the Internet, an Intranet, a local area network (LAN), a wide LAN (WLAN), or a storage area network (SAN) or a communication network configured by combining the networks. The storage device may have access to a device for performing an embodiment of the disclosure via an external port. In addition, an additional storage device on a communication network may have access to the device for performing the embodiment of the disclosure.

In the aforementioned specific embodiments of the disclosure, a component included in the disclosure is expressed in a singular or plural form according to the specific embodiment proposed herein. However, the singular or plural expression is selected properly for a situation proposed for the convenience of explanation, and thus the various embodiments of the disclosure are not limited to a single or a plurality of components. Therefore, a component expressed in a plural form may also be expressed in a singular form, or vice versa.

In addition, in the disclosure, the term “unit”, “module”, or the like may be a hardware component such as a processor or a circuit, and/or a software component executed by the hardware component such as the processor.

The “unit” and the “module” may be implemented by a program stored in an addressable storage medium and executable by the processor. For example, the “unit” and “module” may be implemented by software components, object-oriented software components, class components, and task components, processes, functions, attributes, procedures, subroutines, segments of program code, drivers, firmware, microcode, circuitry, data, databases, data structures, tables, arrays, and variables.

Specific implementations described in the disclosure are only one embodiment, and do not limit the scope of the disclosure in any way. For brevity of the specification, descriptions on the conventional electronic components, control systems, software, and other functional aspects of the systems may be omitted.

In addition, in the disclosure, “including at least one of a, b, or c” may mean “including only a”, “including only b”, “including only c”, “including a and b”, “including b and c”, “including a and c”, or “including a, b, and c”.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display which provides a preview;
a camera including an image sensor;
a memory which stores instructions; and
at least one processor communicatively coupled to the display, the camera, and the memory,
wherein the instructions, when executed by the at least one processor individually or collectively, cause the electronic device to:
display a shooting setting including at least one first set value and a second set value through the display,
change the at least one first set value which determines a shutter speed when the second set value which determines strength of a neural density (ND) filter is changed by a user input, and
display the changed shooting setting through the display along with the preview.

2. The electronic device of claim 1, wherein the instructions, when executed by the at least one processor individually or collectively, further cause the electronic device to:
change the second set value when the at least one first set value is changed by the user input.

3. The electronic device of claim 1,
wherein the at least one first set value includes the shutter speed and sensitivity (ISO) of the image sensor, and
wherein the instructions, when executed by the at least one processor individually or collectively, further cause the electronic device to:
determine an exposure value, based on the shutter speed and the sensitivity, and
display the exposure value through the display.

4. The electronic device of claim 3, wherein the instructions, when executed by the at least one processor individually or collectively, further cause the electronic device to:
obtain the exposure value when the at least one first set value is changed by the user input, and
adjust brightness of the preview, based on the exposure value and the second set value.

5. The electronic device of claim 1, wherein the instructions, when executed by the at least one processor individually or collectively, further cause the electronic device to:
increase a set value of the shutter speed when the second set value increases based on the user input, and
decrease the set value of the shutter speed when the second set value decreases based on the user input.

6. The electronic device of claim 1, wherein the instructions, when executed by the at least one processor individually or collectively, further cause the electronic device to:
when the second set value is first strength, display a first selection range corresponding to the first set value on the display in response to detecting a user input for selecting the first set value,
detect that the second set value is changed from the first strength to second strength by the user input, and
when the second set value is the second strength, display a second selection range corresponding to the first set value on the display in response to detecting the user input for selecting the first set value.

7. The electronic device of claim 1, wherein the instructions, when executed by the at least one processor individually or collectively, further cause the electronic device to:
when the first set value is a first value, display a first strength selection range corresponding to the second set value on the display in response to detecting a user input for selecting the second set value,
detect that the first set value is changed from the first value to a second value by the user input, and
when the first set value is the second value, display a second strength selection range corresponding to the second set value on the display in response to detecting the user input for selecting the second set value.

8. The electronic device of claim 1, wherein the instructions, when executed by the at least one processor individually or collectively, further cause the electronic device to:
determine an exposure time of a shooting system, based on the shutter speed and the strength of the ND filter, and
restrict a change in the second set value, when a difference between a minimum value of the exposure time and a minimum value of the shutter speed is greater than or equal to a predetermined numerical value.

9. The electronic device of claim 1, further comprising:
an illumination sensor which outputs a signal for measuring illumination around the electronic device,
wherein the instructions, when executed by the at least one processor individually or collectively, further cause the electronic device to:
display the second set value adaptively on the display, based on a signal obtained from the illumination sensor.

10. The electronic device of claim 1, wherein the instructions, when executed by the at least one processor individually or collectively, further cause the electronic device to:
determine an exposure time of a shooting system, based on the strength of the ND filter selected based on the user input, and
obtain a plurality of short exposure images, based on the exposure time and the shutter speed selected based on the user input.

11. The electronic device of claim 10, wherein the instructions, when executed by the at least one processor individually or collectively, further cause the electronic device to:
align the plurality of short exposure images, based on at least one of shake information of the electronic device or motion information of an object included in the short exposure images, and
obtain a long exposure image by synthesizing the aligned plurality of short exposure images.

12. A method performed by an electronic device, the method comprising:
displaying a shooting setting including at least one first set value and a second set value through a display of the electronic device;
changing the at least one first set value which determines a shutter speed when the second set value which determines strength of a neural density (ND) filter is changed by a user input; and
displaying the changed shooting setting through the display along with a preview.

13. The method of claim 12, further comprising:
changing the second set value when the at least one first set value is changed by the user input.

14. The method of claim 12,
wherein the at least one first set value includes the shutter speed and sensitivity (ISO) of an image sensor of the electronic device, and
wherein the method further comprises:
determining an exposure value, based on the shutter speed and the sensitivity; and
displaying the exposure value through the display.

15. The method of claim 14, further comprising:
obtaining the exposure value when the at least one first set value is changed by the user input; and
adjusting brightness of the preview, based on the exposure value and the second set value.

16. The method of claim 12, further comprising:
increasing a set value of the shutter speed when the second set value increases based on the user input; and
decreasing the set value of the shutter speed when the second set value decreases based on the user input.

17. The method of claim 12, further comprising:
when the second set value is first strength, displaying a first selection range corresponding to the first set value on the display in response to detecting a user input for selecting the first set value;
detecting that the second set value is changed from the first strength to second strength by the user input; and
when the second set value is the second strength, displaying a second selection range corresponding to the first set value on the display in response to detecting the user input for selecting the first set value.

18. The method of claim 12, further comprising:
when the first set value is a first value, displaying a first strength selection range corresponding to the second set value on the display in response to detecting a user input for selecting the second set value;
detecting that the first set value is changed from the first value to a second value by the user input; and
when the first set value is the second value, displaying a second strength selection range corresponding to the second set value on the display in response to detecting the user input for selecting the second set value.

19. The method of claim 12, further comprising:
determining an exposure time of a shooting system, based on the shutter speed and the strength of the ND filter; and
restricting a change in the second set value, when a difference between a minimum value of the exposure time and a minimum value of the shutter speed is greater than or equal to a predetermined numerical value.

20. The method of claim 12,
wherein the electronic device further includes an illumination sensor which outputs a signal for measuring illumination around the electronic device, and
wherein the method further comprises:
displaying the second set value adaptively on the display, based on a signal obtained from the illumination sensor.
